(19) United States
(12) Patent Application Publication
(10) Pub. No.: US 2019/0347243 A1
(43) Pub. Date: Nov. 14, 2019

(54) SYSTEM AND METHOD FOR COLLABORATIVE SHARING OF INFORMATION

(71) Applicant: Walmart Apollo, LLC, Bentonville, AR (US)

(72) Inventors: Bruce WILKINSON, Rogers, AR (US); Joseph JURICH, Molino, FL (US)

(73) Assignee: Walmart Apollo, LLC, Bentonville, AR (US)

(21) Appl. No.: 16/404,898

(22) Filed: May 7, 2019

Related U.S. Application Data
(60) Provisional application No. 62/669,061, filed on May 9, 2018.

(51) Int. Cl. G06F 16/176; G06F 16/23; H04L 9/06; G06F 16/22; G06F 16/93; H04L 9/30; G06N 20/00; G06F 17/27

(52) U.S. Cl. CPC G06F 16/176; G06F 16/2365; H04L 9/0637; G06F 16/2246; H04L 2209/38; H04L 9/30; G06F 16/2379; G06N 20/00; G06F 17/2705; G06F 16/93

(57) ABSTRACT

A method includes: receiving, from each of a plurality of parties, one or more background intellectual property documents; storing the one or more background intellectual property documents in a block of a blockchain; receiving a joint intellectual property document developed by two or more of the plurality of parties; storing the joint intellectual property document in a different block of the blockchain; comparing and mapping the joint intellectual property document to the one or more background intellectual property documents; generating, based on the comparison and mapping, an affinity level between the joint intellectual property document and the one or more background intellectual property documents; and determining, based on the affinity level, an ownership of the joint intellectual property document.

### CROSS REFERENCE TO RELATED APPLICATION

This patent application claims the benefit of U.S. Provisional Application No. 62/669,061, filed on May 9, 2018, content of which is incorporated by reference herein.

### BACKGROUND

### 1. Technical Field

The present disclosure relates to collaborative sharing of information, and more specifically to a blockchain-based system and method for collaborative sharing of intellectual property (IP).

### 2. Introduction

Blockchain is a shared and distributed ledger that may facilitate the process of recording transactions and tracking assets in a peer-to-peer (P2P) network. An asset may be tangible (e.g., a house, a car, and so on). An asset may also be intangible like IP, such as patents, copyrights, or branding. For example, a blockchain-based system may facilitate a joint IP development by two or more parties and reduce disputes among the parties.

When the two or more parties enter a joint development agreement, a party may not want to disclose their confidential information to the other party. The confidential information may be pre-existing information and referred to as pre-existing documents. There is a need for systems and methods of securely sharing information, and then resolve ownership disputes regarding later developed technology based on the information.

### SUMMARY

Each party may store their pre-existing documents in a corresponding block of the blockchain secured with a private key. The pre-existing documents may be specified with different levels of access authorization. The pre-existing documents may include, but are not limited to, trade secrets, unpublished patent applications, confidential or unpublished technical documents (e.g., white papers), internal reports, provisional patent applications, copyright documents, trademark documents, and other confidential or undisclosed IP-related documents.

A method for performing concepts disclosed herein can include: receiving, by a computer, from each of a plurality of parties, pre-existing documents of that party; storing, by the computer, the pre-existing documents in a block of a blockchain; securing, by the computer, the pre-existing documents in the block of the blockchain such that the pre-existing documents are not accessible to other parties of the plurality of parties except that party from which the pre-existing documents are received; analyzing, by the computer, the pre-existing documents to generate a hierarchy structure with regard to technical field or category of contents of the pre-existing documents; receiving, by the computer, a joint documentation, wherein the joint documentation is developed by two or more of the plurality of parties; storing, by the computer, the joint documentation in a different block of the blockchain; analyzing, by the computer, the joint documentation to generate a hierarchy structure with regard to technical field or category of contents of the joint documentation; comparing and mapping, by the computer, the joint documentation to the pre-existing documents; generating, by the computer, based on the comparison and mapping, an affinity level between the joint documentation and the pre-existing documents; and determining, by the computer, based on the affinity level, an ownership of the joint documentation.

A system configured as disclosed herein can include: a processor; and a computer-readable storage medium having instructions stored which, when executed by the processor, cause the processor to perform operations comprising: receiving, from each of a plurality of parties, pre-existing documents of that party; storing the pre-existing documents in a block of a blockchain; securing the pre-existing documents in the block of the blockchain such that the pre-existing documents are not accessible to other parties of the plurality of parties except that party from which the pre-existing documents are received; analyzing the pre-existing documents to generate a hierarchy structure with regard to technical field or category of contents of the pre-existing documents; receiving a joint documentation, wherein the joint documentation is developed by two or more of the plurality of parties; storing the joint documentation in a different block of the blockchain; analyzing the joint documentation to generate a hierarchy structure with regard to technical field or category of contents of the joint documentation; comparing and mapping the joint documentation to the pre-existing documents; generating, based on the comparison and mapping, an affinity level between the joint documentation and the pre-existing documents; and determining, based on the affinity level, an ownership of the joint documentation.

A non-transitory computer-readable storage medium configured as disclosed herein can have instructions stored which, when executed by a computing device, cause the computing device to perform operations which include: receiving, from each of a plurality of parties, pre-existing documents of that party; storing the pre-existing documents in a block of a blockchain; securing the pre-existing documents in the block of the blockchain such that the pre-existing documents are not accessible to other parties of the plurality of parties except that party from which the pre-existing documents are received; analyzing the pre-existing documents to generate a hierarchy structure with regard to technical field or category of contents of the pre-existing documents; receiving a joint documentation, wherein the joint documentation is developed by two or more of the plurality of parties; storing the joint documentation in a different block of the blockchain; analyzing the joint documentation to generate a hierarchy structure with regard to technical field or category of contents of the joint documentation; comparing and mapping the joint documentation to the pre-existing documents; generating, based on the comparison and mapping, an affinity level between the joint documentation and the pre-existing documents; and determining, based on the affinity level, an ownership of the joint documentation.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an exemplary mesh network between a plurality of parties for joint IP development;

FIG. 2 illustrates an exemplary blockchain based on interactions between the plurality of parties;

FIG. 3 illustrates a block diagram of a blockchain-based process for joint IP development;

FIG. 4 illustrate an exemplary method of developing IP joint by the plurality of parties based on blockchain; and

FIG. 5 illustrates an exemplary computer system.

### DETAILED DESCRIPTION

Systems, methods, and computer-readable storage media configured according to this disclosure are capable of determining ownership of a jointly developed technology among two or more parties. The systems, methods, and computer-readable storage media described herein may also be applicable to any technology development joint by more than one party. By using a blockchain to share technology under development, access to information can be decentralized, that is authentic and whose “chain of title” is irrefutable. The blockchain is tamper-evident. A transaction cannot be tampered with after it is recorded to the blockchain. If a transaction is changed, a new transaction is used to reverse the change, and both transactions are then visible. A single and shared blockchain can provide a mechanism to determine the ownership of the joint developed technology.

In some embodiments, for joint development agreements, one or more parties who join to develop a technology (e.g., IP) may not want to disclose their confidential information to the other party. This information may be pre-existing or developed outside the scope of the agreement. Both categories are generally referred to as pre-existing documents. A blockchain-based system, (e.g., Ethereum system) may be used to allow the parties to place their pre-existing documents into the system. This may be accomplished by, for example, placing each party's pre-existing documents into different blocks of a blockchain. The pre-existing documents for each party may be secured in the system and unavailable to the other party. The disclosed system may then be used to resolve ownership issues regarding a jointly developed technology.

In some embodiments, a P2P network may be used for the disclosed system. If a P2P network is permissioned, it can enable the creation of a parties-only network with proof that the parties are who they say they are and that pre-existing documents are exactly as represented. This may protect the system against tampering, fraud, or cybercrime.

In some embodiments, through the use of identifications (IDs) and permissions, parties can specify which pre-existing document details they want other parties to be permitted to view. Permissions can be expanded for specific parties. For example, as the joint development proceeds, a party may be authorized to access some or all pre-existing documents of all the parties in order to continue the development.

In some embodiments, permissions and cryptography may be used to prevent unauthorized access to the P2P network and to ensure that parties are who they claim to be. Privacy can be maintained through cryptographic techniques and data partitioning techniques to give parties selective visibility into the blockchain. Both the pre-existing documents and the identities of parties who own the pre-existing documents can be masked. After conditions are agreed to, parties cannot tamper with a record of the pre-existing documents and the joint IP.

The pre-existing documents of a party may be analyzed to generate a hierarchical structure with regard to technical field or category of the contents of the pre-existing documents. For example, the pre-existing documents may cover computer technology, further may be related to computer hardware, and even further may be related to central computing unit (CPU) manufacturing, and so on, such that a hierarchical structure of the pre-existing documents can be created. That is, the hierarchical structure may comprise a plurality of technical area levels.

In some embodiments, to resolve the ownership of a joint IP, the disclosed system may map the joint IP to the pre-existing documents. For example, the joint IP and the pre-existing documents may be compared and mapped to build or generate a hierarchical structure or confidence level to determine to which party or parties the joint IP primarily belong. A hierarchical structure for the jointly developed IP can be created.

Once those hierarchical structures are generated, mapping and comparison between the hierarchical structures of the pre-existing documents of each party and the hierarchical structure of the joint IP can be performed to determine an affinity between the hierarchical structures of the pre-existing documents and the joint IP. For example, if a technical area at a level of the hierarchical structures of the pre-existing documents matches a technical area at a corresponding level of the hierarchical structure of the joint IP (e.g., 90% match), a high affinity (e.g., 1) may be assigned to this technical area. Similarly, a medium affinity (e.g., 0.5) may be assigned to a technical area at another level, and so forth. A final affinity between the hierarchical structures of the pre-existing documents and the hierarchical structure of the joint IP may be generated based on those affinities at different technical area levels.

The final affinity may be a median affinity of those affinities at different technical area levels, may be an arithmetic average affinity of those affinities at different technical area levels, may be a maximum affinity of those affinities at different technical area levels, may be a weighted affinity of those affinities at different technical area levels, may be a standard deviation of those affinities at different technical area levels, or may be any meaningful statistical value of those affinities at different technical area levels.

Based on the final affinity, ownership of the joint IP may be determined. That is, a party with a highest affinity may own 100% of the joint IP, 80% of the joint IP, etc. The percentage may be based on the strength of each party's affinity. A party with a lowest affinity may not have any ownership of the joint IP.

A smart contract may be used as a basis for resolving ownership rights to the jointly developed IP. If one party is determined to be the owner of an aspect of the jointly developed technology, another party may be an exclusive licensee in the field of joint development. Any ownership and use rights may be set forth in the smart contract and automatically administered.

In some embodiments, a machine learning scheme, such as a clustering algorithm, a named entity algorithm, a multiclass classification, etc. may be used to analyze the joint IP and the pre-existing documents to determine the ownership of the joint IP. In addition, the machine learning scheme may use natural language processing to compare the pre-existing documents with the joint IP. The natural language processing may include speech recognition, natural language understanding, and natural language generation. The natural language processing may further include morphological segmentation, part-of-speech tagging, parsing, sentence breaking, work segmentation, terminology extraction, machine translation, relationship extraction, sentiment analysis, topic segmentation, word sense disambiguation, automatic summarization, coreference resolution, disclosure analysis, and so on.

Various specific embodiments of the disclosure are described in detail below. While specific implementations are described, it should be understood that this is done for illustration purposes only. Other components and configurations may be used without parting from the spirit and scope of the disclosure, and can be implemented in combinations of the variations provided. These variations shall be described herein as the various embodiments are set forth.

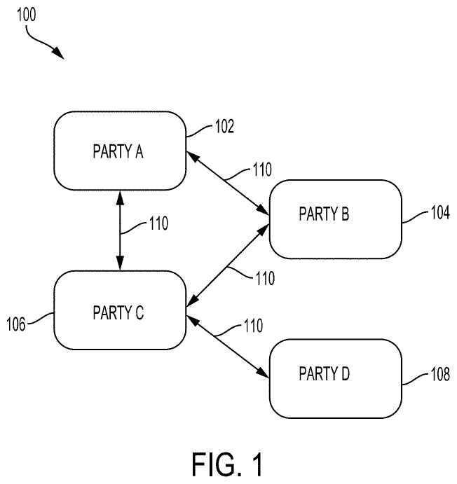

Turning now to FIG. 1, communications between the parties can take the form of a blockchain, where each request and response made by the parties can be added to the blockchain. As any party takes an action (e.g., sending a request, sending a response to a request), that information of the action is added to the blockchain. More specifically, the request, response, or other action is hashed into the previous blockchain. This new, updated blockchain is then distributed to the other parties within the group.

FIG. 1 illustrates an exemplary P2P network 100 between a plurality of parties 102, 104, 106, 108 who may be involved in a joint IP development. A P2P network such as that illustrated in FIG. 1, is a network where each node can relay data from and to other nodes within the network. While P2P networks can be constructed to operate in wired conditions, they are more prevalent in wireless configurations, where messages can be broadcast to other nearby nodes (i.e., not sent to a specific node, but rather all nodes within a given distance of the broadcasting node). When a receiving node is located outside the broadcast range of a transmitting node, intermediate nodes may be required to route the transmission to the receiving node. For example, as illustrated, node 102 (party A) can communicate 110 with nodes 104(party B) and 106 (party C), and nodes 104 and 106 can communicate 110 with each other. However, nodes 102 and 104 cannot communicate with node 108 (party D). Because node 108 can only communicate with node 106, any communications 110 between node 102 and node 108, or between node 104 and node 108, must route through node 106.

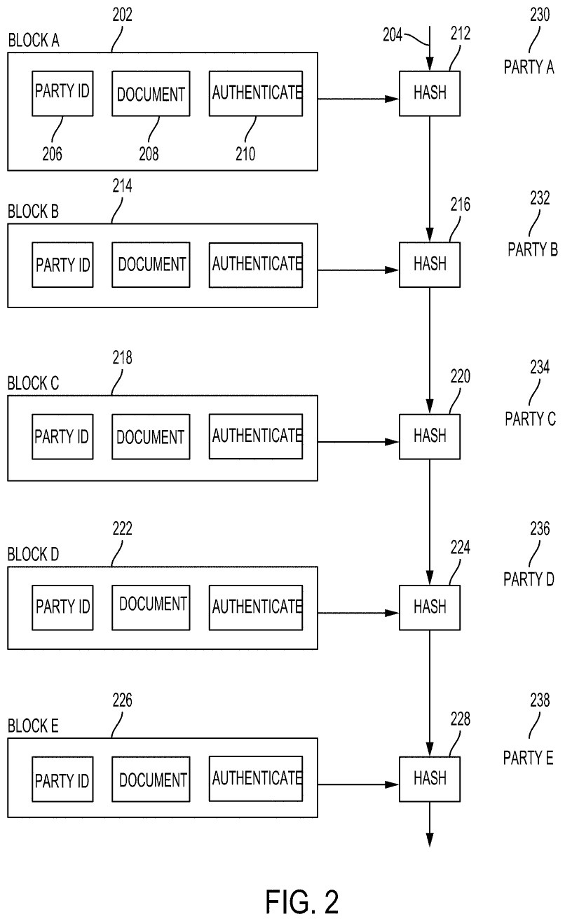

FIG. 2 illustrates an exemplary blockchain system based on interactions between a plurality of parties jointly developing an IP using the network of FIG. 1. Each transaction recorded within the blockchain is a block which can be hashed or otherwise encrypted. As new transactions are added to the blockchain, each transaction's veracity can be tested against the previous blockchain stored by the parties, and can, in some configurations, require confirmation from a defined percentage (usually 50%) of the parties to be added to the blockchain.

The blockchain can take the form illustrated in FIG. 2. In this example, there is a blockchain 204 which is distributed among multiple parties. One of the parties, an initiating party (party A 230), may store their pre-existing documents in a block of the blockchain 204. In this example, a block (Block A 202) is generated to store the pre-existing documents and related data of party A 230. The block 202 added to the blockchain 204 may contain an ID 206 of party A 230, or an address or identification of a device that may be used by the party A 230, and the pre-existing documents 208. In addition, the block 202 can contain an authentication 210 portion. The authentication 210 portion may set restrictions of different levels on the pre-existing documents 208 and the party ID 206. For example, the pre-existing documents 208 and the party ID may be set not to be visible or accessible to other parties other than party A 230. The authentication 210 may authorize other parties to view partial portion or details of the pre-existing documents 208 and the party ID 206, for example, the title of a document. In addition, the authentication 210 may authorize a full access to the pre-existing documents 208 to a specific party, or for a machine learning scheme or an IP analytic engine to compare and analyze the pre-existing documents 208 and the joint IP. The pre-existing documents 208 may be encrypted.

The pre-existing documents 208 may also be part of a smart contract, which is an agreement or set of rules that govern the collaboration between the parties. For example, the smart contract may define contractual conditions under which the pre-existing documents are accessed and evaluated, and disputes are resolved. The smart contract is stored on the blockchain and is executed automatically as part of a transaction.

As the party 230 generates the block 202, the block 202 is hashed 212 into the previous blockchain 204, resulting in an updated blockchain which is distributed among the parties in the group.

The other parties receive the updated blockchain containing the block 202. Party B 232 generates a block 214 to store their pre-existing documents in the blockchain 204. Similar to block 202, the block 214 may store the pre-existing documents and related data of party B 232, an ID of party B 232, or an address or identification of a device that may be used by the party B 232, and an authentication portion.

As the party 232 generates the block 214, the block 214 is hashed 216 into the previous blockchain 204, resulting in an updated blockchain which is distributed among the parties in the group

Similarly, Parties C 234 and D 236 may also be part of the joint development agreement. Blocks 218 and 222 may be generated accordingly and hashed into the blockchain 204, resulting in an updated blockchain which is then distributed among the parties in the group.

When a joint IP is developed under the joint development agreement, the joint IP may be stored in a block 226 and hashed 228 into the blockchain 204. The block 226 may be generated by a party E 238. The party E 238 may be one of the plurality of parties A, B, C, and D. That is, the block 226 can be generated by any of the parties, and distributed to other parties. The block 226 may be accessible to all the parties with a full access authorization.

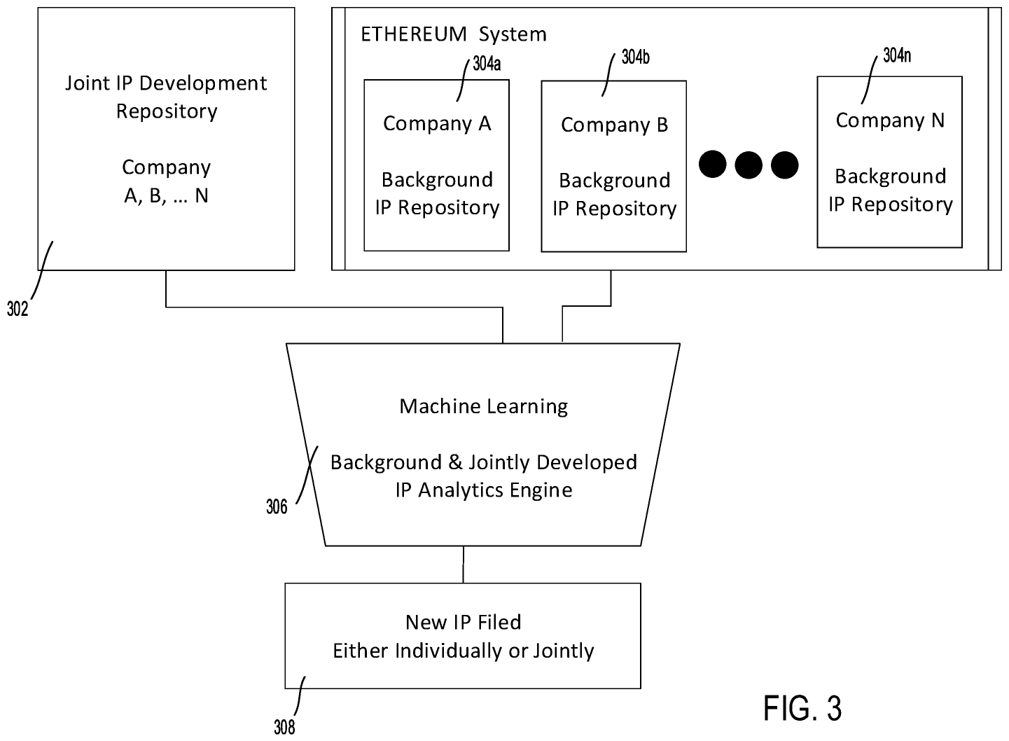

FIG. 3 illustrates a block diagram of a blockchain-based process for determining ownership of a jointly developed IP 302 according to an exemplary embodiment. In this example, an Ethereum system 304 as a blockchain platform, may be used to store and secure the pre-existing documents 304a, 304b . . . 304n from each participating party, for example, companies A, B . . . N. The joint IP 302 may also be stored outside the Ethereum system 304. An IP analytics engine, such as a machine learning scheme 306, may be employed to analyze the joint IP 302 and the pre-existing documents 304a, 304b . . . 304n to determine the ownership of the joint IP 302.

The pre-existing documents may be encrypted so the party loading the documents into the blockchain has a private key. The party may provide its private key so that the machine learning scheme can have a full access to the pre-existing documents and is able to decrypt all of that pre-existing documents to do the comparison and analysis.

Any pre-existing documents can be secured by encryption (e.g., private keys). So neither party can access the other party's pre-existing documents because they do not have the decrypt capabilities. In some embodiments, the only entity that has access to each party's decrypting keys (private keys) is the machine learning scheme that is not owned by any party. As such, the machine learning scheme can be totally impartial because all what the machine learning scheme does is just mapping hierarchy and assigning alignment percentages between the pre-existing documents and the joint IP.

The pre-existing documents and the joint IP may be fed into the machine learning scheme and evaluated to determine who the owner 308 of the joint IP is: should it be just one party, the other party, or a joint ownership, and what attribution of the pre-existing documents are related to the joint IP. For example, text searching and comparison may be performed for the pre-existing documents on the machine learning scheme. A map based on scan of the pre-existing documents can be constructed to build a hierarchy of affinity that applies to the joint IP. Based on the affinities, the primary ownership of the joint IP may be determined, and the other party who is not the primary owner may get a license of the joint IP. The affinity may be a pre-specified threshold, for example, 60% match between the pre-existing documents and the joint IP.

Specifically, clustering algorithm of the machine learning scheme may be used for generating the map. The pre-existing documents can be fed into the clustering algorithm. The pre-existing documents may be clustered in a certain area versus another area using coloring scheme, for example, color blue for company A and color red for company B. Keywords, statements, or phrases as to what that technology the documents relate to may be identified and clustered.

If what is already in the pre-existing documents appears in the joint IP, then the party owning the pre-existing documents may retain an ownership of technology, and the other parties may get a license to use the technology in the context of the joint development. Also, the party owning the pre-existing documents may transfer the ownership, or sell the ownership, or enter into any kind of license agreement with other parties. All these transactions may be part of the smart contract and may be written to the blockchain and noted by the machine learning scheme, such that any impact on the joint development is included in there.

There may have a number of factors that can be analyzed by the machine learning scheme to determine the affinity between the pre-existing documents and the joint IP. The number of factors may include, but are not limited to, date components of the pre-existing documents, prosecution history of any patent or patent application in the pre-existing documents, type of the pre-existing documents, and anything associated with a particular document of the pre-existing documents.

The machine learning scheme may identify and compare the date components of pre-existing documents. The date may be a date a pre-existing document (e.g., a patent application) was created, filed or a date it was loaded to the disclosed system. If the date of the pre-existing document is earlier than the date of the joint IP, the ownership of the joint IP may be attributed to the party who owns the pre-existing document having the earlier date.

For a patent or patent application the machine learning scheme may analyze the prosecution history. For example, any office actions and corresponding responses or any change of assignee, may be analyzed. Based on the prosecution history of the pre-existing document, the ownership of the joint IP may be determined. For example, prior art cited in the prosecution history may indicate that some contents of the joint IP may have already been disclosed or publicly known prior to the joint IP development.

The machine learning scheme may also consider the type of pre-existing documents (e.g., provisional patent application, utility patent application, design patent application, plant patent application, trademark application, etc.). For example, a utility application may be assigned a higher affinity than a provisional application.

In some embodiments, a central smart contract may be used to determine whose pre-existing documents the joint IP leans towards primarily. So if there is any ambiguous language in the contract between parties, this can facilitate to determine the real owner or the predominant owner or non-dominant owner. In some embodiments, the joint IP may not be stored in the blockchain as the joint IP are known to all parties.

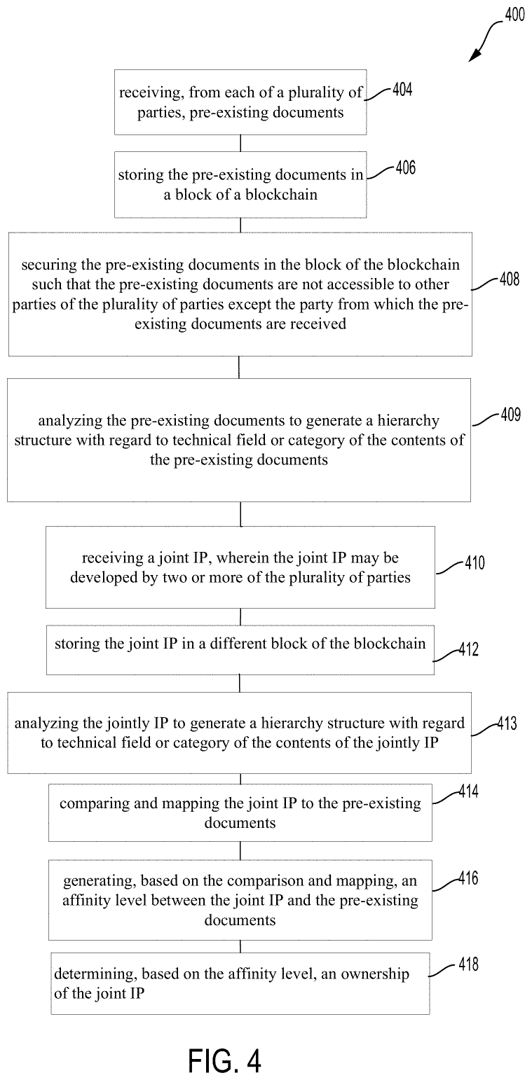

FIG. 4 illustrates an exemplary method 400 of system and method for collaborative sharing of information based on blockchain. The method 400 may be implemented in the above disclosed systems, may include the following steps, and thus some details may not be repeated herein.

At step 404, pre-existing information, such as documents, from each of a plurality of parties, are received at the system. Each party may send their pre-existing documents to the system via a computing device.

At step 406, the pre-existing documents are stored in a block of a blockchain. The pre-existing documents may be stored in corresponding blocks of the blockchain and may be secured and set at various visible or access authentication levels.

At step 408, the pre-existing documents are secured in the block of the blockchain based on the access levels such that the pre-existing documents may not be accessible to other parties of the plurality of parties except the party from which the pre-existing documents are received. In some embodiments, securing the pre-existing documents in the block of the blockchain may be performed using a public-key cryptography.

At step 409, the pre-existing documents are analyzed to generate a hierarchical structure with regard to technical field or category of the contents of the pre-existing documents, as described above. The hierarchy structure of the pre-existing documents is stored in the blockchain.

At step 410, a joint IP is received. The joint IP may be developed by two or more of the plurality of parties.

At step 412, the joint IP is stored in a different block of the blockchain. In some embodiments, the joint IP may not be stored in a block of the blockchain where pre-existing documents are stored.

At step of 413, the joint IP is analyzed to generate a hierarchical structure with regard to technical field or category of the contents of the joint IP, the details of which can be referred to the discussions described before. The hierarchy structure of the joint IP is stored.

At step 414, the joint IP and the pre-existing documents are compared and mapped. As described above, this step may be performed by a machine learning scheme using, for example, natural language processing. The comparison and mapping may be conducted based on the hierarchical structure of the pre-existing documents and the hierarchy structure of the joint IP.

At step 416, an affinity level between the joint IP and the pre-existing documents is generated, based on the comparison and mapping, as discussed before. The machine learning scheme can analyze with which affinities of the pre-existing documents the joint IP may mostly align.

At step 418, an ownership of the joint IP is determined based on the affinity level.

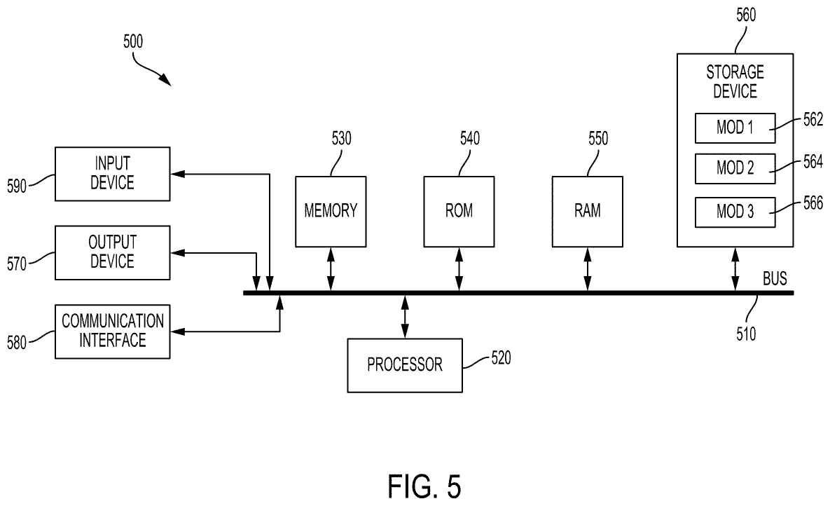

With reference to FIG. 5, an exemplary system 500 can include a processing unit (CPU or processor) 520 and a system bus 510 that couples various system components including the system memory 530 such as read only memory (ROM) 540 and random access memory (RAM) 550 to the processor 520. The system 500 can include a cache of high speed memory connected directly with, in close proximity to, or integrated as part of the processor 520. The system 500 copies data from the memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The memory 530 can include multiple different types of memory with different performance characteristics. It can be appreciated that the disclosure may operate on a computing system 500 with more than one processor 520 or on a group or cluster of computing devices networked together to provide greater processing capability. The processor 520 can include any general purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing system 500, such as during start-up. The computing system 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing system 500. In one aspect, a hardware module that performs a particular function includes the software component stored in a tangible computer-readable storage medium in connection with the necessary hardware components, such as the processor 520, bus 510, output device 570 as display, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the system 500 is a small, handheld computing device, a desktop computer, or a computer server.

Although the exemplary embodiment described herein employs the hard disk as the storage device 560, other types of computer-readable media which can store data that are accessible by a computer, such as magnetic cassettes, flash memory cards, digital versatile disks, cartridges, random access memories (RAMs) 550, and read only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing system 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing system 500. The communications interface 580 generally governs and manages the user input and system output. There is no restriction on operating on any particular hardware arrangement and therefore the basic features here may easily be substituted for improved hardware or firmware arrangements as they are developed.

The concepts disclosed herein can also be used to improve the computing systems which are performing, or enabling the performance, of the disclosed concepts. For example, information associated with pre-existing documents, smart contract, jointly developed technology, etc., can be generated by local computing devices. In a standard computing system, the information will then be forwarded to a central computing system from the local computing devices. However, systems configured according to this disclosure can improve upon this “centralized” approach.

One way in which systems configured as disclosed herein can improve upon the centralized approach is combining the data from the respective local computing devices prior to communicating the information from the local computing devices to the central computing system. Rather than transmitting each individual piece of data each time new data is generated, such as the jointly developed technology, the various computing devices can cache the generated data for a period of time and combine the generated data with any additional data which is generated within the period of time. This withholding and combining of data can conserve bandwidth due to the reduced number of transmissions, can save power due to the reduced number of transmissions, and can increase accuracy due to holding/verifying the data for a period of time prior to transmission.

Another way in which systems configured as disclosed herein can improve upon the centralized approach is adapting a decentralized approach, where data is shared among all the individual nodes/computing devices of the network, and the individual computing devices perform calculations and determinations as required. Such a configuration may be more power and/or bandwidth intensive than a centralized approach, but can result in a more dynamic system because of the ability to modify assignments and requirements immediately upon making that determination. In addition, such a system can be more secure, because there are multiple points of failure (rather than a single point of failure in a centralized system).

It is worth noting that a “hybrid” system might be more suitable for some specific configurations. In this approach, a part of the network/system would be using the centralized approach (which can take advantage of the bandwidth savings described above), while the rest of the system is utilizing a de-centralized approach (which can take advantage of the flexibility/increased security described above).

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A blockchain-based method comprising:
receiving, by a computer, from each of a plurality of parties, pre-existing documents of that party;
storing, by the computer, the pre-existing documents in a block of a blockchain;
securing, by the computer, the pre-existing documents in the block of the blockchain such that the pre-existing documents are not accessible to other parties of the plurality of parties except that party from which the pre-existing documents are received;
analyzing, by the computer, the pre-existing documents to generate a hierarchical structure with regard to technical field and category of contents of the pre-existing documents;
receiving, by the computer, a joint documentation, wherein the joint documentation is developed by two or more of the plurality of parties;
storing, by the computer, the joint documentation in another block of the blockchain;
analyzing, by the computer, the joint documentation to generate a hierarchy structure with regard to technical field or category of contents of the joint documentation;
comparing and mapping, by the computer, the joint documentation to the pre-existing documents based on the hierarchical structure of the joint documentation and the hierarchical structure of the pre-existing document;
generating, by the computer, based on the comparison and mapping, an affinity level between the joint IP and the pre-existing documents; and
determining, by the computer, based on the affinity level, an ownership of the joint documentation.

2. The method of claim 1, further comprising defining affinity rules in a smart contract and automatically determining the affinity level based on the rules.

3. The method of claim 1, wherein the securing the pre-existing documents in the block of the blockchain is performed using a public-key cryptography.

4. The method of claim 1, wherein the comparing and mapping the joint documentation to the pre-existing documents is performed based on machine learning.

5. The method of claim 4, wherein the machine learning comprises natural language processing.

6. The method of claim 1, wherein the affinity level is determined in accordance with a specified match percentage between the joint documentation and the pre-existing documents.

7. The method of claim 1, wherein the comparing and mapping the joint documentation to the pre-existing documents is based on the hierarchical structure of the joint documentation and the hierarchy structure of the pre-existing documents.

8. The method of claim 4, wherein the machine learning is authorized to access to the joint documentation and the pre-existing documents.

9. A system, comprising:
a processor; and
a computer-readable storage medium having instructions stored which, when executed by the processor, cause the processor to perform operations comprising:
receiving, from each of a plurality of parties, pre-existing documents of that party;
storing the pre-existing documents in a block of a blockchain;
securing the pre-existing documents in the block of the blockchain such that the pre-existing documents are not accessible to other parties of the plurality of parties except that party from which the pre-existing documents are received;
analyzing the pre-existing documents to generate a hierarchical structure with regard to technical field or category of contents of the pre-existing documents;
receiving a joint documentation, wherein the joint documentation is developed by two or more of the plurality of parties;
storing the joint documentation in a different block of the blockchain;
analyzing the joint documentation generate a hierarchical structure with regard to technical field or category of contents of the joint documentation;
comparing and mapping the joint documentation to the pre-existing documents;
generating, based on the comparison and mapping, an affinity level between the joint IP and the pre-existing documents; and
determining, based on the affinity level, an ownership of the joint documentation.

10. The system of claim 9, wherein the pre-existing documents are published and/or unpublished patents.

11. The system of claim 9, wherein the securing the pre-existing documents in the block of the blockchain is performed using a public-key cryptography.

12. The system of claim 9, wherein the comparing and mapping the joint documentation to the pre-existing documents is performed based on machine learning.

13. The system of claim 12, wherein the machine learning comprises natural language processing.

14. The system of claim 9, wherein the affinity level is determined in accordance with a specified match percentage between the joint documentation and the pre-existing documents.

15. The system of claim 9, wherein the comparing and mapping the joint documentation to the pre-existing documents is based on the hierarchical structure of the joint documentation and the hierarchical structure of the pre-existing documents.

16. The system of claim 12, wherein the machine learning is authorized to access to the joint documentation and the pre-existing documents.

17. A non-transitory computer-readable storage medium having instructions stored which, when executed by a computing device, cause the computing device to perform operations comprising:
receiving, from each of a plurality of parties, pre-existing documents of that party;
storing the pre-existing documents in a block of a blockchain;
securing the pre-existing documents in the block of the blockchain such that the pre-existing documents are not accessible to other parties of the plurality of parties except that party from which the pre-existing documents are received;
analyzing the pre-existing documents to generate a hierarchical structure with regard to technical field or category of contents of the pre-existing documents;
receiving a joint documentation, wherein the joint documentation is developed by two or more of the plurality of parties;
storing the joint documentation in a different block of the blockchain;
analyzing the joint documentation generate a hierarchical structure with regard to technical field or category of contents of the joint documentation;
comparing and mapping the joint documentation to the pre-existing documents;
generating, based on the comparison and mapping, an affinity level between the joint IP and the pre-existing documents; and
determining, based on the affinity level, an ownership of the joint documentation.

18. The medium of claim 17, wherein the pre-existing documents are published and/or unpublished patents.

19. The medium of claim 17, wherein the comparing and mapping the joint documentation to the pre-existing documents is performed based on machine learning.

20. The medium of claim 19, wherein the machine learning comprises natural language processing.
